(19) United States
(12) Patent Application Publication
(10) Pub. No.: US 2025/0168556 A1
(43) Pub. Date: May 22, 2025

(54) SYSTEM AND METHOD FOR ENABLING AUDIO STEERING

(71) Applicant: Samsung Electronics Co., Ltd., Suwon-si (KR)

(72) Inventors: G Abhishek KUMAR, Suwon-si (KR); Abhishek SHARMA, Noida (IN); Sfurti RAJPUT, Noida (IN); Shailja SHARMA, Noida (IN); Anil Kumar SAINI, Noida (IN)

(21) Appl. No.: 19/027,708

(22) Filed: Jan. 17, 2025

Related U.S. Application Data
(63) Continuation of application No. PCT/KR2022/019055, filed on Nov. 29, 2022.

(30) Foreign Application Priority Data
Sep. 7, 2022 (IN) 202211051021

(51) Int. Cl. H04R 1/34; G06V 40/16; H04R 1/28

(52) U.S. Cl. CPC H04R 1/345; G06V 40/171; H04R 1/2803

(57) ABSTRACT

A system and method for enabling audio steering at an electronic device is provided. The method comprises generating, ultrasonic waves for registering a facial map of a user, and capturing, facial images of the user. Further the method identifies facial features of the user from the captured facial images. The method thereafter registers, ultrasonic signatures, based on the facial features and the facial map of the user. The method includes detecting, a spatial location of two or more ultrasonic signatures associated with two or more facial features of the user within a specified vicinity of an electronic device of the user, to detect user's ears position. The method comprises converging, a first non-audible frequency and second non-audible frequency near the user's ears position for producing an audible range of frequency for the user, wherein the production of the audible range of the frequency enables the audio steering.

### CROSS-REFERENCE TO RELATED APPLICATIONS

This application is a continuation of International Application No. PCT/KR2022/019055 designating the United States, filed on Nov. 29, 2022, in the Korean Intellectual Property Receiving Office and claiming priority to Indian Patent Application number 202211051021, filed on Sep. 7, 2022, in the Indian Patent Office, the disclosures of each of which are incorporated by reference herein in their entireties.

### BACKGROUND

### Field

The disclosure relates to techniques for directing audio and, for example, the disclosure relates to systems and methods for enabling audio steering at mobile device(s) to bring multi-user experience without requirement of any additional hardware.

### Description of Related Art

Users of electronic devices are provided with a number of facilities. For example, to provide an audio output to the users, the electronic devices such as smartphones are equipped with speakers and other technologies that are capable of providing the audio output via wireless and/or wired devices. Generally, a speaker produces a sound wave by oscillating a cone, causing vibrations of air molecules. Sound waves in general are wave-like movements of air or water molecules. Because these media are elastic and generally homogeneous, naturally occurring sound travels in all directions radially from the source of generation, e.g., audio is audible to all those who are present in the vicinity of the source.

Audio steering or directed audio is a technique to focus the sound waves to a particular user or set of users, so that only targeted audience receives the audio. The technology to direct audio can either be wired or wireless. Wired earphones are the most commonly used accessory used to listen to audio privately, and nowadays they are gradually being replaced by in-ear wireless devices (for e.g., truly wireless earbuds) as the more natural choice due to their seamless form factor. However, there are a number of limitations of these technologies of directing an audio output wirelessly through in-ear wireless devices, for instance, there is always a requirement of an in-ear wireless device. Moreover, the wired or wireless devices can also cause adverse effects on hearing health of a person. In order to deal with such limitation, an audio steering speaker is developed based on the currently known technologies. This audio steering speaker is based on ultrasound beamforming. More particularly, this audio steering speaker uses heterodyning principle to convert incoming sound waves (20 Hz to 20 kHz) to two or more, ultrasonic frequencies (>20 KHz) and transmits them in such a manner that they converge at a particular focal point/area (e.g., near a particular listener's ears) to create the original sound wave. The original sound wave so created provides to the user an experience that's like wearing invisible headphones. Also, said audio steering speaker includes in built cameras for identification of the user/listener and keeping a track of user's movement to direct the audio around user's ear.

Although the audio steering speaker is capable of directing the audio around user's ear, but there are a number of limitations of such audio steering speaker. Some limitations of this audio steering speaker are as below:

User needs to have extra expense of buying a speaker to have invisible headphones effect

Multiple users will require multiple speakers

This audio steering speaker fails to differentiate between different users

This audio steering speaker limits user's movement as it works in line-of-sight of source of audio transmission and audio reception and it needs to be carried around

Therefore, there are a number of limitations of the current solutions and there is a need in the art to provide a method and system for enabling audio steering to bring multi-user experience and overcome the limitations of currently known solutions.

The above information is presented as background information only to assist with an understanding of the disclosure. No determination has been made, and no assertion is made, as to whether any of the above might be applicable as prior art with regard to the disclosure.

### SUMMARY

Embodiments of the disclosure provide a method and system for enabling audio steering.

Embodiments of the disclosure bring multi-user experience via enabling audio steering at a user device of multiple users.

Embodiments of the disclosure eliminate/reduce the need of wired devices, in-ear wireless devices and/or audio steering speakers to direct an audio output around a particular user's ear.

Embodiments of the disclosure enable audio steering via a user device such as a smartphone.

Embodiments of the disclosure provide an audio device that can direct sound to a specific user (e.g., a registered) in an event multiple users are present within a specific area range.

Embodiments of the disclosure provide a seamless audio steering irrespective of the movement of the user.

Embodiments of the disclosure deliver a customised audio to a particular user's ear(s) via audio steering, wherein the audio is customised based on said user's preference.

Embodiments of the disclosure provide and use dual impression signature(s) for enabling audio steering in the most efficient manner.

Embodiments of the disclosure provide a method and system for enabling audio steering.

In an example embodiment, a method for enabling audio steering is provided. The method comprises: generating one or more ultrasonic waves for use in registering a facial map of a user; capturing one or more facial images of the user; identifying a plurality of facial features of the user from the captured one or more facial images; registering an ultrasonic signature for each of the identified plurality of facial features by at least registering echo of the one or more ultrasonic waves reflected from each of the identified plurality of facial features; detecting a spatial location of two or more ultrasonic signatures associated with two or more facial features of the user within a vicinity of an electronic device of the user using one or more target ultrasonic waves; detecting a spatial location of ears of the user using the detected spatial location of the two or more ultrasonic signatures associated with the two or more facial features of the user; and converging a first non-audible frequency and second non-audible frequency at a specified proximity to the spatial location of the ears of the user to produce an audible range of frequency for the user, wherein the production of the audible range of the frequency enables the audio steering.

In an example embodiment, a system for enabling audio steering is provided. The system comprises: memory storing instructions and at least one processor, wherein: the instructions, when executed by the at least one processor individually or collectively, cause the system to generate, one or more ultrasonic waves for use in registering a facial map of a user; capture one or more facial images of the user; identify, a plurality of facial features of the user from the captured one or more facial images; register an ultrasonic signature for each of the identified plurality of facial features at least by registering echo of the one or more ultrasonic waves reflected from each of the identified plurality of facial features; detect a spatial location of two or more ultrasonic signatures associated with two or more facial features of the user within a specified vicinity of an electronic device of the user using one or more target ultrasonic waves, and detect a spatial location of ears of the user using the detected spatial location of the two or more ultrasonic signatures associated with the two or more facial features of the user; and converge a first non-audible frequency and second non-audible frequency at a specified proximity to the spatial location of the ears of the user for producing an audible range of frequency for the user, wherein the production of the audible range of the frequency enables the audio steering.

In an example embodiment, a non-transitory computer-readable memory is provided. The non-transitory computer readable memory is provided storing instructions that, when executed by at least one processor, comprising processing circuitry, individually and/or collectively, of a system, cause the system to: generate one or more ultrasonic waves for use in registering a facial map of a user; capture one or more facial images of the user; identify a plurality of facial features of the user from the captured one or more facial images; register an ultrasonic signature for each of the identified plurality of facial features by registering echo of the one or more ultrasonic waves reflected from each of the identified plurality of facial features; detect a spatial location of two or more ultrasonic signatures associated with two or more facial features of the user within a specified vicinity of an electronic device of the user using one or more target ultrasonic waves; detect a spatial location of ears of the user using the detected spatial location of the two or more ultrasonic signatures associated with the two or more facial features of the user; and converge a first non-audible frequency and a second non-audible frequency at a specified proximity to the spatial location of the ears of the user for producing an audible range of frequency for the user.

To further illustrate the advantages and features of the disclosure, a more detailed description will be rendered with reference to various example embodiments thereof, which are illustrated in the appended drawings. It will be appreciated that these drawings depict example embodiments of the disclosure and are therefore not to be considered limiting its scope. The disclosure will be described and explained with additional specificity and detail with reference to the accompanying drawings.

### BRIEF DESCRIPTION OF THE DRAWINGS

The above and other aspects, features, and advantages of certain embodiments of the present disclosure will be more apparent from the following detailed description, taken in conjunction with the accompanying drawings, in which like characters represent like parts throughout the drawings, and in which:

FIG. 1 is a block diagram illustrating an example configuration of a system for enabling audio steering, according to various embodiments;

FIG. 2 is a diagram illustrating generation of one or more facial images of a user and a facial map of the user, according to various embodiments;

FIGS. 3A, 3B, 3C and 3D are diagrams illustrating example registration of one or more ultrasonic signatures for a user, according to various embodiments;

FIGS. 4A and 4B are diagrams illustrating an example of detecting a spatial-location of ear(s) of a user, according to various embodiments;

FIG. 5 is a diagram illustrating example customization of an audio data based on a preference of a user, according to various embodiments;

FIG. 6 is a diagram illustrating an example of converging two non-audible frequencies for enabling audio steering, according to various embodiments;

FIG. 7 is a diagram illustrating two example wave matrices of echo waveforms, according to various embodiments;

FIG. 8 is a flowchart illustrating an example method for enabling audio steering, according to various embodiments; and

FIG. 9 is a diagram illustrating an example use case, according to various embodiments.

Further, skilled artisans will appreciate that elements in the drawings are illustrated for simplicity and may not have necessarily been drawn to scale. For example, the flowcharts illustrate the method in terms of operations involved to help to improve understanding of aspects of the disclosure. Furthermore, in terms of the construction of the device, one or more components of the device may have been represented in the drawings by conventional symbols, and the drawings may show those specific details that are pertinent to understanding the various example embodiments of the disclosure so as not to obscure the drawings with details that may be readily apparent to those of ordinary skill in the art.

### DETAILED DESCRIPTION

To be better understood by those skilled in the art, the present disclosure is described in the following description with reference to the attached drawings.

The description provides various example embodiments. The various embodiments of the disclosure are provided with specific details to provide a thorough understanding of such embodiments. However, these embodiments may be practiced without the provided specific details. For example, various elements such as for e.g., circuits, systems, processes, and other units may be shown as components in block diagram form in order not to obscure the disclosure in unnecessary detail. Also, the disclosure may be embodied in many different forms and should not be construed as limited to the various embodiments set forth herein; rather, these embodiments are provided so that this disclosure will be thorough and complete. It should be understood that the function and arrangement of elements might be changed without departing from the essence and scope of the disclosure as set forth herein. The terminology used in the detailed description of the various example embodiments illustrated in the accompanying drawings is not intended to be limiting. In the drawings, like numbers refer to like elements.

Various embodiments may be described as a process which is for e.g., in the form of a flow diagram, a flowchart, a structure diagram, a data flow diagram, or a block diagram. In these embodiments the operations may be described as a sequential process, however many of the operations can be performed in parallel or concurrently. In a process an order of the operations may also be re-arranged. In addition, a figure may indicate that a process is terminated when its operations are completed, however there may be additional steps that are not included in the figure.

Various features of the present disclosure can each be used independently of one another or with any combination of other features. Some of the problems as discussed above may or may not be addressed by an individual feature of the present disclosure. However, some of these problems may be addressed by a combination of features of the present disclosure.

Terms such as “exemplary” and/or “demonstrative” indicate an illustration, an instance, or an example, and the disclosed subject matter is not limited by such examples. Additionally, it should be noted that no “exemplary” and/or “demonstrative” aspect or design described herein may be construed as preferred or advantageous over other aspects or designs, and it also should not preclude equivalent exemplary structures and techniques known to those of ordinary skill in the art.

Furthermore, the detailed description or the claims may contain terms such as “has,” “contains,” and “includes,” etc., however it is important to note that such terms are intended to be inclusive—in a manner similar to an open transition word such as the term “comprising”—without precluding any additional or other elements.

As used herein, a “processing unit” or “operating processor” includes one or more processors, microprocessors, microcomputers, microcontrollers, digital signal processors, central processing units, state machines, logic circuitries, and/or any devices that manipulate signals based on operational instructions. The processing unit may also refer to any logic circuitry for processing instructions. Among other capabilities, the processing unit may be configured to fetch and execute computer-readable instructions stored in the memory. More specifically, the processor or processing unit is a hardware processor.

As used herein, “storage unit” or “memory unit” refers to a machine or computer-readable medium including any mechanism for storing information in a form readable by a computer or similar machine. The computer-readable medium may include a volatile memory, such as static random-access memory (SRAM) and dynamic random-access memory (DRAM), and/or non-volatile memory, such as read only memory (ROM), erasable programmable ROM, flash memories, hard disks, optical disks, magnetic tapes and/or other types of machine-accessible storage media. The storage unit stores at least the data that may be required by one or more units of the system to perform their respective functions.

As used herein, “a mobile device”, “a handheld device”, “a wireless communication device”, “a mobile communication device”, “a user equipment”, “a user device”, “a smart-user-device”, “a smart-device”, “an electronic device”, and “a communication device” may be any electrical, electronic and/or computing device or equipment, capable of implementing the features of the disclosure. The mobile device may include, but is not limited to, a mobile phone, smart phone, a laptop, a tablet computer, a wearable device or any other computing device which is capable of implementing the features of the disclosure. Also, the mobile device may contain at least one input means configured to receive an input from one or more unit(s)/system(s) which are required to implement the features of the disclosure.

As disclosed in the background section, existing technologies have many limitations and in order to address at least some of the limitations of the prior known solutions, the disclosure provides a solution for enabling audio steering at a mobile device of user(s). For example, the disclosure enables audio steering in, for example, two steps e.g., 1) by registering one or more users to enable the audio steering at a mobile device of said one or more users, and 2) by searching a spatial-location of ears of the one or more registered users for producing an audible range of frequency near the spatial-location of the ears. The step 1 e.g., the registration of the one or more users encompasses generation of one or more dual impression signatures (DISs) (e.g., ultrasonic signature(s)) using a data captured via an image sensor unit and an ultrasonic sensor unit. Also, the step 2 e.g., searching of the spatial-location of the ears and the production of the audible range of frequency near said spatial-location encompasses searching the spatial-location of the ears based on detection of two most prominent matched DISs. Data of the two most prominent matched DISs are used to determine a spatial angle of ear's position with respect to the spatial-location of two prominent facial features corresponding to the two most prominent matched DISs. Once a spatial-location of the ears of a user is identified, a first non-audible and second non-audible frequency is converged at a close (e.g., specified) proximity to the spatial-location of the ears to produce the audible range of frequency for the user. In the disclosure a personal handheld device of the user may be utilized as an intermediate medium to cast audio to the user. Therefore, based on the implementation of features of the disclosure the audio steering to multiple users within an environment may be provided without requirement of any additional hardware.

Hereinafter, various example embodiments of the disclosure will be described in greater detail with reference to the accompanying drawings.

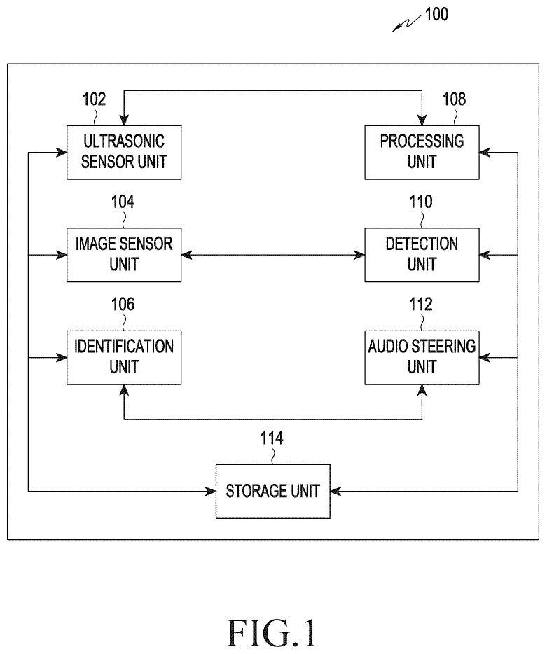

FIG. 1 is a block diagram illustrating an example configuration of a system for enabling audio steering, according to various embodiments.

In an implementation, the system 100 may be connected to a mobile device or any handheld device and in another implementation, the system 100 may resides within the mobile device or any handheld device to implement the features of the disclosure. The system 100 comprises at least, at least one ultrasonic sensor unit (e.g., including an ultrasonic sensor) 102, at least one image sensor unit (e.g., including an image sensor) 104, at least one identification unit (e.g., including various circuitry) 106, at least one processing unit (e.g., including at least one processor comprising processing circuitry) 108, at least one detection unit (e.g., including various circuitry) 110, at least one audio steering unit (e.g., including various circuitry) 112 and at least one storage unit (e.g., including a memory) 114. FIG. 1 may not indicate the interconnection(s) between all the components/units of the system 100, for the purpose of clarity, however all of the components/units of the system 100 are assumed to be connected to each other unless otherwise indicated below. Additionally, in FIG. 1 only a few units are shown, however, the system 100 may comprise multiple such units or the system 100 may comprise any such numbers of the units, as required to implement the features of the disclosure.

The system 100 is configured to enable audio steering at the mobile device/handheld device, with the help of the interconnection between the components/units of the system 100.

For example, in order to enable audio steering at a mobile device of the user, the system 100 is first configured at the mobile device of the user. Further, the ultrasonic sensor unit 102 of the system is configured to generate, one or more ultrasonic waves for registering a facial map of a user. For example, the ultrasonic sensor unit 102 may generate the ultrasonic waves, wherein such ultrasonic waves are reflected back from the face of the user. Thereafter, the ultrasonic sensor unit 102 captures the reflected ultrasonic waves to generate the facial map of the user using these reflected ultrasonic waves.

The image sensor unit 104 of the system 100 is configured to capture, one or more facial images of the user. In an implementation an image sensor unit 104 such as a camera unit of the mobile device of the user may be used to capture the one or more facial images and/or one or more facial videos of the user to implement the features of the disclosure.

The one or more facial images of the user and the facial map of the user is provided to the identification unit 106 and the processing unit 108. In an implementation the identification unit 106 may be a unit similar to the processing unit 108 and is configured to identify facial features such as ears, eyes and/or nose etc., from a visual feed received from the image sensor unit 104. Also, the identification unit 106 may further include a feature embedding unit, or is connected to the feature embedding unit. Also, in an implementation the processing unit 108 may include a signal processor unit. The processing unit 108 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

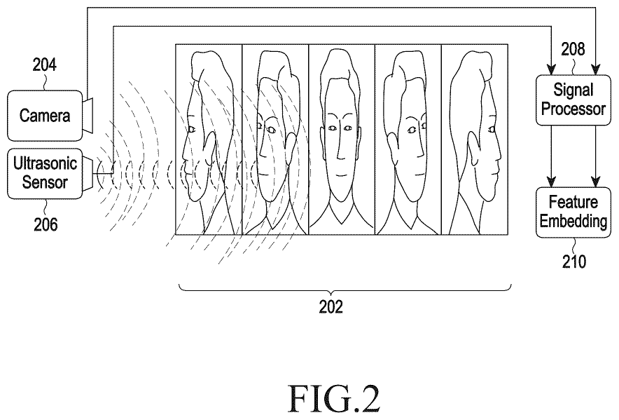

FIG. 2 is a diagram illustrating example generation of one or more facial images of a user and a facial map of the user, according to various embodiments.

Referring to FIG. 2, a diagram illustrating generation of one or more facial images of the user and the facial map of the user is shown, in accordance with an example embodiment. FIG. 2 illustrates that a camera 204 and an ultrasonic sensor 206 is used to capture respectively, one or more facial images and one or more echo images (reflections of the ultrasonic waves) from different facial angles 202 of a user. The one or more facial images and the one or more echo images are then provided to a signal processor unit 208 and a feature embedding unit 210 for further processing, facial feature identification and generation of one or more ultrasonic signatures for user registration.

For example, the identification unit 106 is configured to identify, a plurality of facial features of the user from the captured one or more facial images. Each facial feature from the plurality of facial features may be one of a nose, ear, eye and any other such facial feature. The processing unit 108 (e.g., the signal processing unit) is then configured to map one or more of the identified plurality of facial features with the one or more echo images. The processing unit 108 via the feature embedding unit is configured to register, an ultrasonic signature for each of the identified plurality of facial features for user registration, wherein the processing unit 108 registers the ultrasonic signature for each of the identified plurality of facial features by registering echo of the one or more ultrasonic waves reflected from said each of the identified plurality of facial features. In an implementation the processing unit 108 is further configured to register the ultrasonic signature for each of the identified plurality of facial features by registering said each of the identified plurality of facial features.

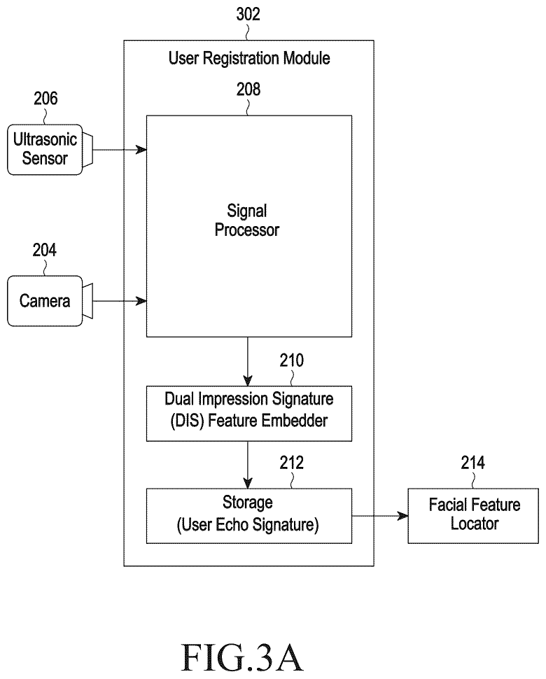

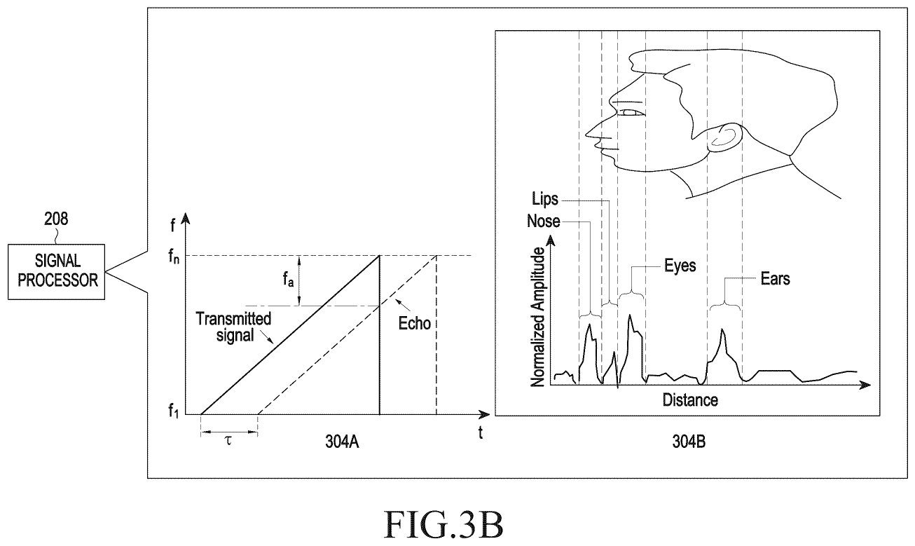

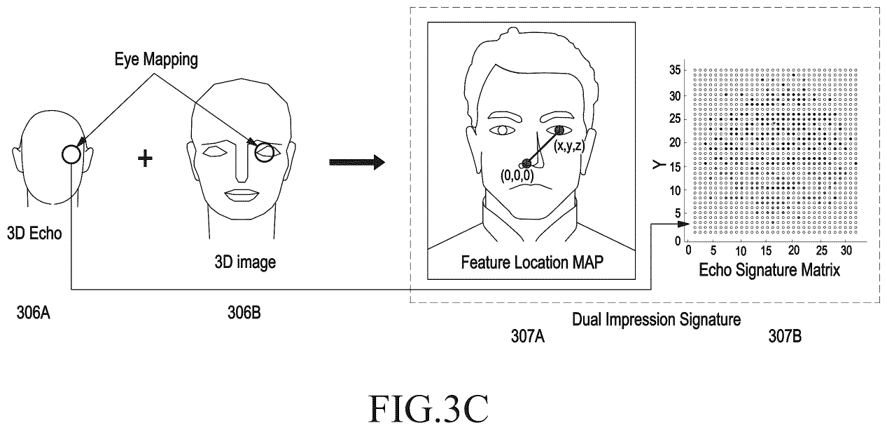

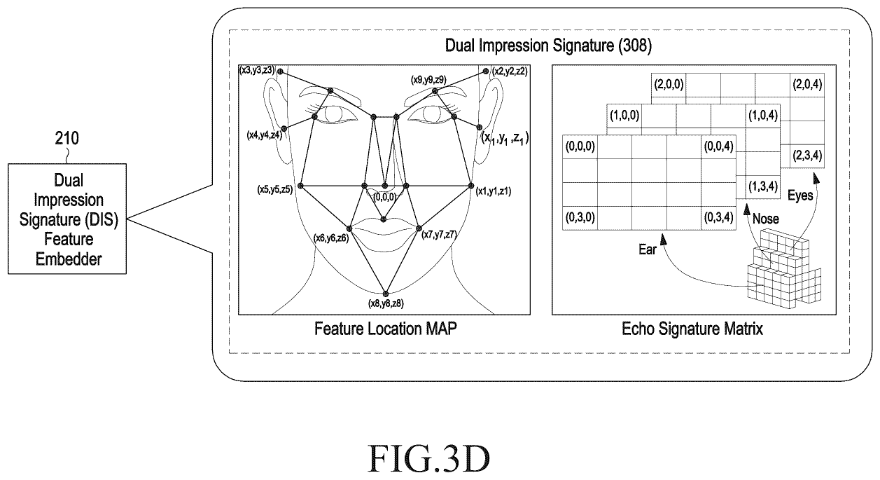

FIGS. 3A, 3B, 3C and 3D are diagrams illustrating examples of registration of one or more ultrasonic signatures for a user are shown according to various embodiments.

For example, FIG. 3A illustrates that a user registration module 302 is connected to the camera 204 and the ultrasonic sensor 206. The user registration module 302 comprises a signal processor/signal processing unit 208, a dual impression signature (DIS) feature embedder/feature embedding unit (e.g., including various circuitry and/or executable program instructions) 210 and a storage unit (e.g., including a memory) 212. In an implementation the storage unit 212 is same or similar to the storage unit 114. Further the storage unit 212 is connected to a facial feature locator (e.g., including various circuitry and/or executable program instructions) 214. The camera 204 and the ultrasonic sensor 206 (for e.g., including but not limited to at least one of a speaker, an in-screen fingerprint scanner and the like sensor) are configured to capture the one or more ultrasonic signatures (e.g., the one or more DISs). For example, a user's smartphone camera may be configured to visually scan user's facial features in a visual stream from left right & front. Simultaneously an ultrasonic sensor transmits ultrasonic waves and receives the echoes after reflecting from the user's face. Thereafter, the one or more dual impression signatures are generated based on a relative mapping of facial scanning and received echoes.

The relative mapping of facial scanning and received echoes may be determined by the signal processing unit 208. For example, using the signal processing unit [208], one or more ultrasonic signals are transmitted and its echoes are received. Thereafter, the signal processing unit 208 maps these echoes with one or more facial features identified through visual feeds. An example transmitted signal and an example echo signal are provided as below:

### Transmitted Signal

$${s}_{T} ( t ) = \{ \begin{matrix}A cos [ 2 π ( {f}_{l} t + mt ∠ / 2 ) ] & 0 \leq t \leq T \\ 0 & t < 0 or t > T\end{matrix}$$

A: Amplitude
fₗ; Low frequency
fₕ: High Frequency
T: Time Duration
m=(fₕ−fₗ)/T

### Echo Signal

S_{R}(t)=ΣᵢF(f, ri, αᵢ)S_{T}(t−τᵢ)
F(f,ri,θi): Transfer function determined by transmitter
fₗ: Low frequency
fₕ: High Frequency
T: Time Duration
m=(fₕ−fₗ)/T

Also, referring to FIG. 3B, two example graphs 304 A and 304 B are provided, depicting a relative mapping of facial scanning and received echoes determined based on the above example transmitted signal and echo signal.

After determining the relative mapping of facial scanning and received echoes, the dual impression signature (DIS) feature embedder 210 is configured to generate the one or more dual impression signatures (DISs) (e.g., the one or more ultrasonic signatures) based on said relative mapping. For example, a 3D image is formed from the one or more images of the face of the user that are taken from different angles by the camera 204. A 3D echo image is formed using the one or more echo images of the face of the user captured by the ultrasonic sensor 206. In an implementation both the 3D image and the 3D echo image are saved in form of matrices. Thereafter, the 3D image is mapped with 3D echo image using the DIS feature embedder 210, to identify feature(s) position in the 3D echo image. In an implementation the DIS feature embedder 210 may consider a nose position as origin (0,0,0) and then maps all other features of the face with respect to the nose/origin forming a feature location map. The Feature Location map therefore conveys feature location taking nose tip as origin. Also, in an implementation after identifying the feature positions on the 3D echo image, those features data is extracted and saved in matrices forming a 3D echo signature matrix. The echo signature matrix uniquely identifies the user's facial features. The DIS feature embedder 210 then generates the one or more DISs based on the feature location map and the echo signature matrix. Furthermore, in an implementation, an array of DIS corresponding to each facial feature (such as eyes, nose, ear, cheekbone, lips etc.) is maintained, and the generated DISs are registered on the storage unit 114 and/or a local storage of the mobile device for user identification. For example, in order to enable audio steering, the stored DIS(s) are used to identify one or more specific portions of the face of the user where from one or more echoes are received.

Referring to FIG. 3C, an example mapping of a 3D echo image with a 3D image is shown, in accordance with the implementation of the features of the disclosure. For example, FIG. 3C illustrates mapping of an eye in a 3D echo image 306 A with an eye in a 3D image 306 B to identify feature position e.g., eye position in the 3D echo image 306 A. Also, based on the mapping, a nose position as origin (0,0,0) is identified, and then the eye at (x, y, z) location is identified to form a feature location map 307 A. Also, FIG. 3C illustrates that after identifying the feature positions on the 3D echo image 306 A, those features data is extracted and saved in matrices forming a 3D echo signature matrix 307 B. Thereafter, based on the feature location map 307 A and the 3D echo signature matrix 307 B, a dual impression signature is generated. Furthermore, an example dual impression signature 308 generated by the DIS feature embedder 210 is illustrated in FIG. 3D, in accordance with the implementation of the features of the disclosure. The DIS as generated based on the implementation of the features of the disclosure provides a technical advantage over the currently known solutions of audio steering as this DIS is a two-dimensional signature (e.g., visual +ultrasonic) and therefore improves precision in quick facial feature identification of a user.

Further, once the echo of the one or more ultrasonic waves are registered in the storage unit 114 as the ultrasonic signature (or a DIS) for the identified plurality of facial features and/or once the plurality of facial features are registered in the storage unit as the ultrasonic signature (or the DIS) for said plurality of facial features, a spatial-location of two or more ultrasonic signatures associated with two or more facial features of the user within a vicinity of the mobile device of the user may be detected to enable audio steering. In an implementation, the vicinity of the mobile device may be a surrounding area of the mobile device up to 1 meter or 2 meters, but the disclosure is not limited thereto and the vicinity range may be increased (for e.g., 5 meter) depending on the hardware configuration of the mobile device. More particularly, to enable audio steering, the detection unit 110 is configured to detect, the spatial-location of the two or more ultrasonic signatures associated with the two or more facial features of the user within the vicinity of the mobile device of the user using one or more target ultrasonic waves, for instance one or more echoes of the one or more target ultrasonic waves reflected from the user's face may be used to search these two or more ultrasonic signatures. Also, these two or more ultrasonic signatures are searched from a pre-stored set of ultrasonic signatures defined for the user (e.g., the plurality of DISs registered for the user on the storage unit 114 and/or on the local memory of the mobile device of the user). As disclosed above, each ultrasonic signature from the pre-stored set of ultrasonic signatures (e.g., each registered DIS) is determined based on a mapping of a set of facial features of the user (e.g., 3D image) with a set of echoes of a set of ultrasonic waves reflected from the user (e.g., 3D echo image).

Further, the detection unit 110 is configured to detect a spatial-location of ears of the user using the detected spatial-location of the two or more ultrasonic signatures associated with two or more facial features of the user. For example, the detection unit 110 is configured to use the detected spatial-location of the two or more ultrasonic signatures to identify a relative location of the ears of the user, wherein the relative location of the ears of the user is identified to get exact coordinates of the ears with respect to the mobile device. Also, the relative location of the ears depicts a relation (such as an angle) of the position of the ears with respect to the facial features corresponding to the two or more ultrasonic signatures. Thereafter, according to the ears position, an audio beam is focused at ear's spatial-location to enable audio steering. For example, after detecting the spatial-location of the ears of the user using the spatial-location of the two or more ultrasonic signatures associated with the two or more facial features of the user, the audio steering unit 112 is configured to converge, a first non-audible frequency and second non-audible frequency at a close proximity to the spatial-location of the ears of the user for producing an audible range of frequency for the user, wherein the production of the audible range of the frequency enables the audio steering. Also, the audible range of the frequency includes a frequency range from about 20 Hz to 20 kHz, and any frequency falling outside the audible range of the frequency is non-audible frequency. Moreover, to converge the first non-audible frequency and the second non-audible frequency at the close proximity to the spatial-location of the ears of the user, the audio steering unit 112 is configured to receive, an audio data from one or more audio media devices. The audio steering unit 112 then processes this audio data at least to transform the audio data into a consumable form. Thereafter, the processed audio data is converted into the first non-audible frequency and the second non-audible frequency by the audio steering unit 112. Also, the audio steering unit 112 then directs the first non-audible frequency and the second non-audible frequency towards the close proximity to the spatial-location of the ears of the user for converging the first non-audible frequency and the second non-audible frequency at the close proximity to the spatial-location of ears of the user. In an implementation, the audio data received from the one or more audio media devices is further processed by the processing unit 108 to customize the audio data based on a preference of the user. The processing unit 108 may include an audio processor unit comprising a content personaliser unit and/or a frequency and pitch determiner (e.g., each including various circuitry and/or executable program instructions) to customize the audio data. In an example, the audio data is customized as per user preferences, altering the bass, censoring audio etc. Therefore, in the given implementation, when the first non-audible frequency and the second non-audible frequency are converged at the close proximity to the spatial-location of the ear of the user, a customized audio data is generated for the user.

Also, in an implementation, the detection unit 110 of the system 100 is further configured to detect, one of a mobility and an immobility of the user based on echo of the one or more ultrasonic waves, wherein the one of the mobility and the immobility is detected while converging the first non-audible frequency and the second non-audible frequency. Also, in an event the immobility of the user is detected, the audio steering unit 112 is then configured to maintain an audio steering continuity at the close proximity to the spatial-location of the ears of the user based on the immobility of the user. For example, the detection unit 110 is configured to detect one of a match and a mismatch of echo of the one or more ultrasonic waves with one or more previously received echoes. In case of the successful match the immobility of the user is determined, otherwise the mobility of the user is determined. Therefore, the detection unit 110 detects a change in the spatial-location of one or more of the ultrasonic signatures corresponding to the identified plurality of facial features based on the detection of the mismatch, e.g., detection of the mobility of the user. Also, based on the detection in the change in the spatial-location of one or more of the ultrasonic signatures corresponding to the identified plurality of facial features, the detection unit 110 detects a new spatial-location of said one or more of the ultrasonic signatures corresponding to the identified plurality of facial features. The detection unit 110 thereafter detects a new spatial-location of ears of the user using the new spatial-location of the one or more of the ultrasonic signatures corresponding to the identified plurality of facial features. Additionally, the detection unit 110 is configured to detect a distance between a previous spatial-location of ears of the user and the new spatial-location of ears of the user to maintain an audio steering continuity at the close proximity to the new spatial-location of the ears of the user. Therefore, the sonic transmission to the new spatial-location of ears of the user is continued.

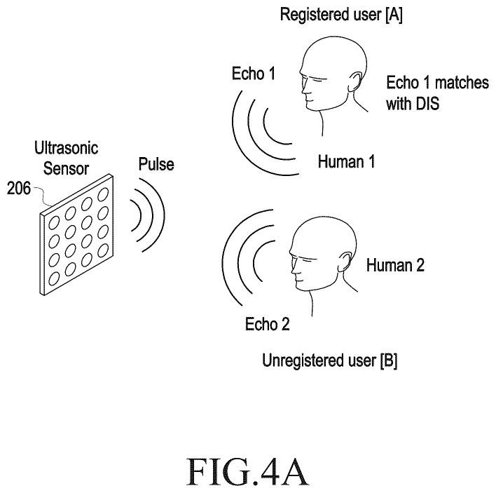

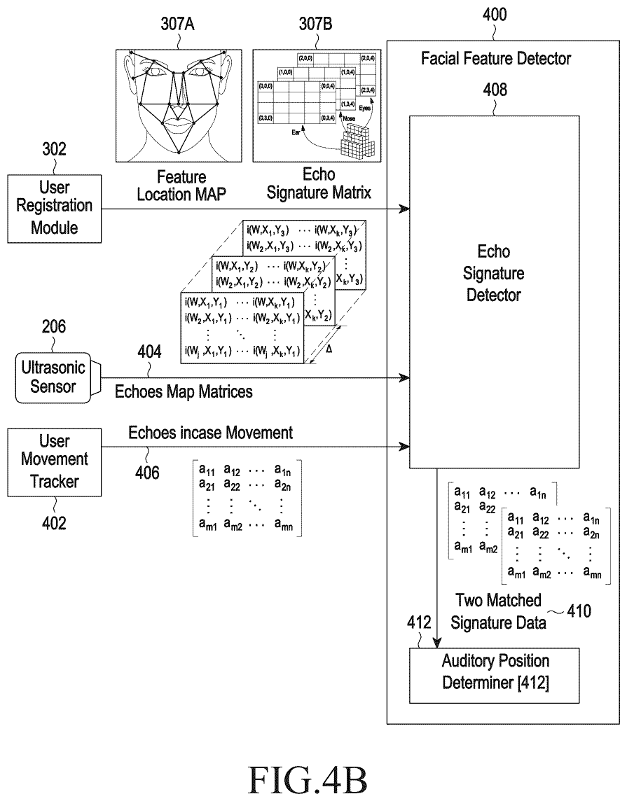

FIGS. 4A and 4B are diagrams illustrating examples of detecting a spatial-location of ear(s) of a user, according to various embodiments.

For example, FIG. 4A illustrates that an ultrasonic pulse is sent by the ultrasonic sensor 206 in all directions. Thereafter, 3D echoes of the ultrasonic pulse from a registered user A and an unregistered user B are received back at the ultrasonic sensor 206, which is then matched with a DIS cache, to identify the registered user A. For the registered user A, the echo (e.g., echo 1) matches with one or more DIS stored in the DIS cache. Thereafter, based on the matching, two most matching DISs of the registered user's facial feature are shortlisted. Further, a spatial-location of these two facial features is used to identify a spatial-location of ear(s) of the user, to get exact coordinates with respect to the mobile device of the user. Thereafter, according to an ear position, an audio beam is focused at ear's spatial-location. Furthermore, FIG. 4B illustrates a facial feature detector 400, wherein in an implementation the facial feature detector 400 is same or similar to the detection unit 110. The facial feature detector 400 comprises an echo signature detector (e.g., including various circuitry and/or executable program instructions) 408 and an auditory position determiner (e.g., including various circuitry and/or executable program instructions) 412. The echo signature detector 408 is connected to the user registration module 302, the ultrasonic sensor 206 and a user movement tracker 402. The user registration module 302 provides at least one of one or more pre-stored feature location maps 307 A and one or more pre-stored echo signature matrix 307 B to the echo signature detector 408. The ultrasonic sensor 206 of the mobile device is placed in a defined distance from the user and provides one or more echoes map matrices 404 to the echo signature detector 408. Also, the user movement tracker 402 provides one or more echoes in case of user movement 406 to the echo signature detector 408. The echo signature detector 408 locates spatial positions of user's facial features. For example, the echo signature detector 408 matches a matrix data of all objects received in the echoes (e.g., the one or more echoes map matrices 404) with a signature matrix data of registered user's DIS(s) (e.g., one or more pre-stored echo signature matrix 307 B). Thereafter, the echo signature detector 408 considers two prominent matched DISs of the registered user and evaluates a spatial position of facial features corresponding to the two matched DISs. Also, in an example 3 ultrasonic transducers having spherical radius ranges r₁, r₂, r₃ at location (A1={0,0,0}, A2={x₂,0,0} & A3={x₃, y₃,0}), spatial-location of user's feature (x, y, z) can be found as:

$$x = ( {{r}_{1}}^{2} - {{r}_{2}}^{2} + {{x}_{2}}^{2} ) / 2 {x}_{2}$$

$$y = ( {{r}_{1}}^{2} - {{r}_{3}}^{2} + {{y}_{3}}^{2} + {{x}_{3}}^{2} - 2 {x}_{3} x ) / 2 {y}_{3}$$

$$z = \pm √ ( {{r}_{1}}^{2} - {x}^{2} - {y}^{2} )$$

The echo signature detector 408 provides the data of the two most prominent matched DISs 410 to the auditory position determiner 412. Further, the auditory position determiner 412 is configured to find the spatial position of registered user's ears. For example, the data of the two most prominent matched DISs are used to determine the angle at which facial features are located to the ears. In an implementation an angle θ subtended at the ear of the user by the lines joining the two prominent features is calculated. Further, the ear's spatial-location is calculated using angle 0. In an example, given two points p₁(a,b) and p₂(x,y), finding position of p₃(u,v) which is 0 degrees with line p₁p₂ and r-distance away from the point p₁ is calculated as:

$${( l + {l}_{p} )}^{2} + {{l}_{n}}^{2} = {{l}_{h}}^{2} where , l = √ ( {( a - x )}^{2} + {( b - y )}^{2} ) ; \\ {l}_{h} = √ ( {( u - x )}^{2} + {( v - y )}^{2} ) ; {l}_{n} = r sin θ and$$

$${l}_{p} = r cos θ$$

$$α = 2 r cos θ √ ( {( a - x )}^{2} + {( b - y )}^{2} ) + {r}^{2} + {a}^{2} + {b}^{2} - 2 ax - 2 by and β = {r}^{2} - {a}^{2} - {b}^{2}$$

$$u ( a - x ) + v ( b - y ) = ( α - β ) / 2$$

Once the spatial position of registered user's ears is determined, the same is provided by the Auditory Position Determiner 412 to a sonic transmission unit.

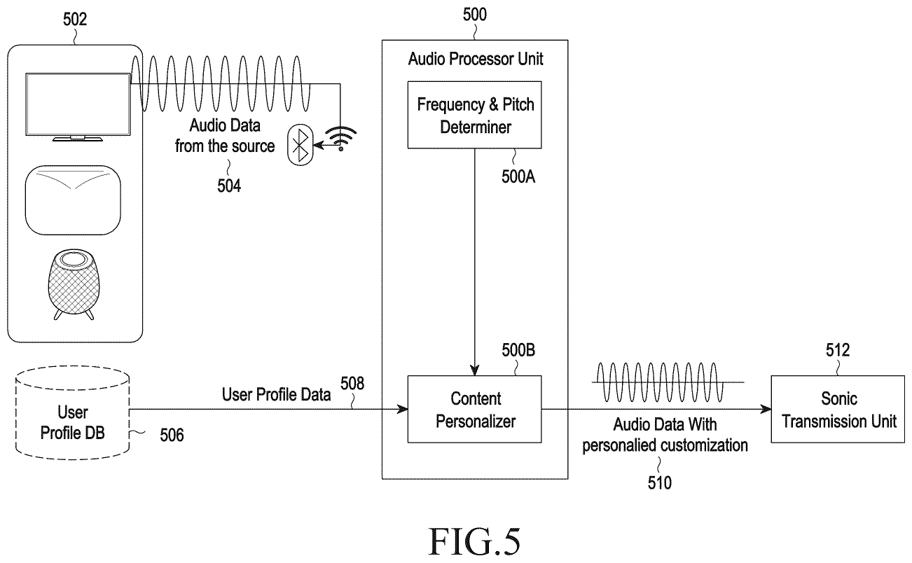

FIG. 5 is a diagram illustrating example customization of an audio data based on a preference of a user, according to various embodiments.

FIG. 5 illustrates an audio processor unit 500, wherein in an implementation the audio processor unit 500 may be a part of the processing unit 108. Also, the audio processor unit 500 comprises a frequency and pitch determiner 500 A and a content personalizer 500 B. The audio processor unit 500 receives an audio data 504 from one or more sources (e.g., audio media devices) 502 via one or more wireless configurations such as via Bluetooth, Wi-Fi, UWB and/or the like wireless mediums. The frequency & pitch determiner 500 A parses the audio data 504 to generate its deterministic key values. Also, the content personalizer 500 B adjusts the audio data 504 to match the user's preferences, while also censoring parts, if required. For example, the content personalizer 500 B receives from a user profile database (DB) 506 a user profile data 508. The user profile DB 506 maintains a user profile based on a user's preferences. The content personalizer 500 B then customizes the audio data 504 based at least on the user profile data 508, for example the audio data is customized based on user preferences, alteration of the bass, censoring audio etc. Also, the content personalizer 500 B then provides to the sonic transmission unit 512, the audio data with personalized customization 510.

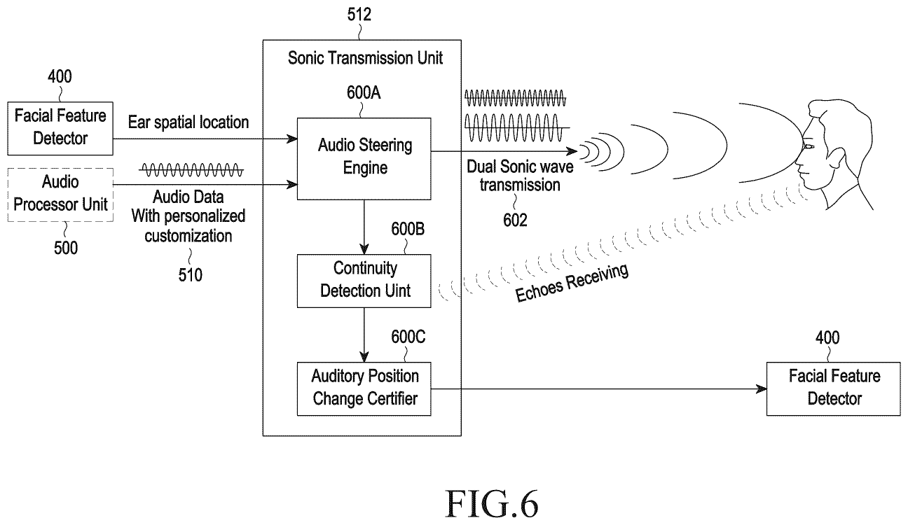

FIG. 6 is a diagram illustrating an example of converging two non-audible frequencies for enabling audio steering, according to various embodiments.

For example, FIG. 6 illustrates that the sonic transmission unit 512 is configured to receive: 1) the audio data with personalized customization 510 from the audio processor unit 500, and 2) the ear spatial position of the registered user from the facial feather detector 400. The sonic transmission unit 512 comprises an audio steering engine 600 A, a continuity detection unit 600 B and an auditory position change certifier 600 C. In an implementation the audio steering engine 600 A may be same or similar to the audio steering unit 112, and the continuity detection unit 600 B may be same or similar to the detection unit 110. Also, in an implementation the auditory position change certifier 600 C may be a processor that may be a part of the detection unit 110 or connected to the detection unit 110. The audio steering engine 600 A converts a single sonic sound wave (frequency F) into at least two ultrasonic waves (fᵢ & fⱼ) using heterodyne principle. Thereafter, the audio steering engine 600 A directs these ultrasonic waves towards a spatial position of user's ear (for e.g., as depicted at 602). Further, when these two ultrasonic frequencies converge close to the ear, an audible frequency of order |fᵢ−fⱼ|=F is formed to enable the audio steering. In an example, for frequencies f₁ and f₂, when they are combined resulting frequency is given by:

$$sin ( 2 π {f}_{1} t ) sin ( 2 π {f}_{2} t ) = \frac{1}{2} {\underbrace{cos [ 2 π ( {f}_{1} - {f}_{2} ) t ]}}_{\begin{matrix}Difference of \\ 24 \\ frequencies\end{matrix}} - \frac{1}{2} {\underbrace{cos [ 2 π ( {f}_{1} + {f}_{2} ) t ]}}_{\begin{matrix}Sum of \\ frequencies\end{matrix}}$$

Furthermore, the transmission and convergence of two or more sound waves via a non-linear medium like air results in 4 different kinds of waveforms, e.g., 1) an audible original frequency (˜2 KHz), 2) transmitted sonic waves 52 KHz and 50 KHz, 3) resultant frequency as sum of transmitted waves, e.g., 50+52=102 KHz (inaudible), and 4) most crucial and useful product of this convergence is the wave with difference of frequencies which is same as or similar to the original wave and is audible, 2 KHz.

Further, the continuity detection unit 600 B is configured to maintain the audio steering continuity at the user's ear. The continuity detection unit 600 B receives echoes of ultrasonic waves (transmitted by the audio steering engine 600 A) reflected from user's facial features (including ear's). If said received echoes are same as or similar to that of the previously received echo(es), implying the user position has not changed, so audio steering continues. Else the continuity detection unit 600 B forward these received echoes to the auditory position change certifier 600 C for confirmation.

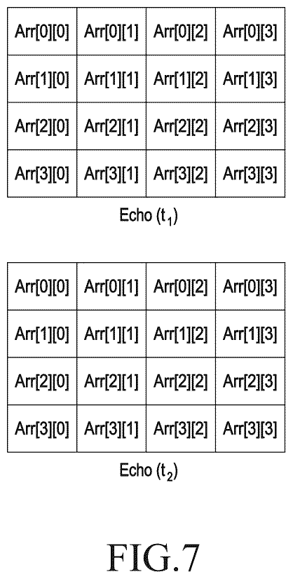

FIG. 7 illustrates two example wave matrices of echo waveforms, according to various embodiments.

In an example, the currently and previously received echo waveforms are converted to wave matrix, for e.g., two example wave matrices e.g., echo (t₁) and echo (t₂) as provided in FIG. 7. The currently and previously received echo waveforms (for e.g., the two example wave matrices e.g., echo (t₁) and echo (t₂)) are then compared. In case the echo (t₁) is equal to the echo (t₂), no movement of user position is confirmed and audio steering is then continued at the same spatial-location. Also, in case the echo (t₁) is not equal to the echo (t₂), the echo data is then passed to the auditory position change certifier 600 C for user position change confirmation.

In an implementation, the auditory position change certifier 600 C constantly matches received echoes with user's DIS(s) corresponding to his facial features of ears to ensure immobility of user. In case of mismatch of echoes with user's DIS(s) corresponding to its ears beyond a certain threshold, a significant user movement is detected by the auditory position change certifier 600 C. After detecting the significant user movement, the received echoes are then forwarded to the facial feature detector 400 for recalibration of new spatial-location of user's ear. This step helps in reducing processing time in recalibration of new position. Also, after recalibration of new spatial-location of user's ear, the sonic transmission to the new spatial-location is continued. Also, an example matching of received echoes with user's DIS(s) corresponding to his facial features of ears is provided as below:

For example, an echo matrix at time to is matched with the matrix at time t₁ generate a match quotient (Q). Thereafter, Q(t) is compared with threshold value, ‘ω’ to confirm if user has moved from its last known position. The user position change is provided as below:

$$User Position Change = \{ \begin{matrix}True & if Q ( {t}_{i} ) > ω \\ False & if Q ( {t}_{i} ) < ω\end{matrix}$$

In an event, if user movement is confirmed, the facial feature detector 400 is requested to recalibrate the user position. Else, steering continues at same spatial-location.

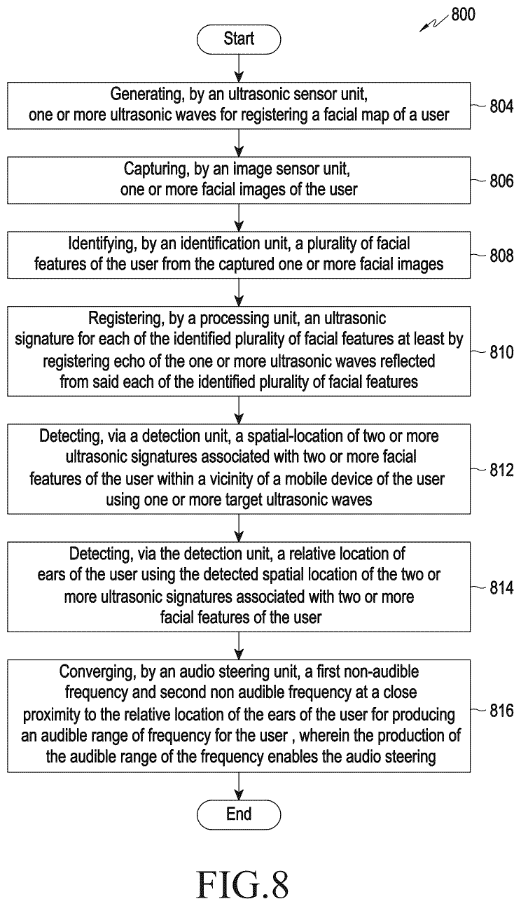

FIG. 8 is a flowchart illustrating an example method for enabling audio steering, according to various embodiments.

In an implementation the method is performed by the system 100. Further, in an implementation, the system 100 is connected to a mobile device or any handheld device of a user and in another implementation the system 100 is placed in the mobile device or any handheld device of the user to implement the features of the disclosure. The method therefore enables audio steering at the mobile device/handheld device.

At operation 804, the method comprises generating, by the ultrasonic sensor unit 102, one or more ultrasonic waves for registering a facial map of a user. For example, the ultrasonic sensor unit 102 may generate the ultrasonic waves, wherein such ultrasonic waves are reflected back from the face of the user. Thereafter, the ultrasonic sensor unit 102 captures the reflected ultrasonic waves to generate the facial map of the user using these reflected ultrasonic waves.

At operation 806, the method comprises capturing, by the image sensor unit 104, one or more facial images of the user. In an implementation an image sensor unit 104 such as a camera unit of the mobile device of the user may be used to capture the one or more facial images and/or one or more facial videos of the user to implement the features of the disclosure.

At operation 808, the method comprises identifying, by the identification unit 106, a plurality of facial features of the user from the captured one or more facial images. Each facial feature from the plurality of facial features may be one of a nose, ear, eye and any other such facial feature.

At operation 810, the method comprises registering, by the processing unit 108, an ultrasonic signature for each of the identified plurality of facial features. For example, for registration of the ultrasonic signature for each of the identified plurality of facial features, the processing unit 108 maps the identified plurality of facial features with the one or more ultrasonic waves that are reflected back from the face of the user (e.g., the one or more echo images). In an implementation, the registering of the ultrasonic signature for each of the identified plurality of facial features comprises registering echo of the one or more ultrasonic waves reflected from said each of the identified plurality of facial features. Also, in an implementation, registering of the ultrasonic signature for each of the identified plurality of facial features further comprises registering said each of the identified plurality of facial features. Furthermore, in an implementation, an array of ultrasonic signatures (DISs) corresponding to each facial feature (such as eyes, nose, ear, cheekbone, lips etc.) is maintained, and the generated DISs are registered on the storage unit 114 and/or a local storage of the mobile device for user identification. More specifically, in order to enable audio steering, the stored DIS(s) are used to identify one or more specific portions of the face of the user where from one or more echoes are received.

Further, once the echo of the one or more ultrasonic waves are registered in the storage unit 114 as the ultrasonic signature (or a DIS) for the identified plurality of facial features and/or once the plurality of facial features are registered in the storage unit 114 as the ultrasonic signature (or the DIS) for said plurality of facial features, the method then leads to operation 812.

At operation 812, the method comprises detecting, via the detection unit 110, a spatial-location of two or more ultrasonic signatures associated with two or more facial features of the user within a vicinity of the mobile device of the user using one or more target ultrasonic waves, for instance one or more echoes of the one or more target ultrasonic waves reflected from the user's face may be used to search these two or more ultrasonic signatures. In an implementation, the vicinity of the mobile device may be a surrounding area of the mobile device up to 1 meter or 2 meters, but the disclosure is not limited thereto and the vicinity range may be increased (for e.g., 5 meter) depending on the hardware configuration of the mobile device. Also, these two or more ultrasonic signatures are searched from a pre-stored set of ultrasonic signatures defined for the user (e.g., the plurality of DISs registered for the user on the storage unit 114 and/or on the local memory of the mobile device of the user). As disclosed above, each ultrasonic signature from the pre-stored set of ultrasonic signatures (e.g., each registered DIS) is determined based on a mapping of a set of facial features of the user with a set of echoes of a set of ultrasonic waves reflected from the user.

At operation 814, the method comprises detecting, via the detection unit 110, a relative location of ears of the user using the detected spatial-location of the two or more ultrasonic signatures associated with two or more facial features of the user. For example, the operation of detecting, via the detection unit 110, the spatial-location of the ears of the user further comprises using the detected spatial-location of the two or more ultrasonic signatures to identify a relative location of the ears of the user, wherein the relative location of the ears of the user is identified to get exact coordinates of the ears with respect to the mobile device. Also, the relative location of the ears depicts a relation (such as an angle) of the position of the ears with respect to the facial features corresponding to the two or more ultrasonic signatures. Thereafter, according to the ear position, an audio beam is focused at ear's spatial-location to enable audio steering. For example, after detecting the spatial-location of the ears of the user using the spatial-location of the two or more ultrasonic signatures associated with the two or more facial features of the user the method leads to operation 816, to enable audio steering. At operation 816 the method comprises converging, by the audio steering unit 112, a first non-audible frequency and second non-audible frequency at a close proximity to the spatial-location of the ears of the user for producing an audible range of frequency for the user, wherein the production of the audible range of the frequency enables the audio steering. Also, the audible range of the frequency includes a frequency range from about 20 Hz to 20 kHz, and any frequency falling outside the audible range of the frequency is non-audible frequency.

Also, the operation of converging, by the audio steering unit 112, the first non-audible frequency and the second non-audible frequency at the close proximity to the spatial-location of the ears of the user firstly comprises receiving, at the audio steering unit 112, an audio data from one or more audio media devices. Thereafter, it encompasses processing, by the audio steering unit 112, the audio data at least to transform the audio data into a consumable form. Further, the operation leads to converting the processed audio data into the first non-audible frequency and the second non-audible frequency. Thereafter, the operation encompasses directing the first non-audible frequency and the second non-audible frequency towards the close proximity to the spatial-location of the ears of the user for converging the first non-audible frequency and the second non-audible frequency at the close proximity to the spatial-location of the ears of the user. In an implementation, the audio data received from the one or more audio media devices is further processed by the processing unit 108 to customize the audio data based on a preference of the user. In an example, the audio data is customized as per user preferences, altering the bass, censoring audio etc. Therefore, in the given implementation, when the first non-audible frequency and the second non-audible frequency are converged at the close proximity to the spatial-location of the ear of the user, a customized audio data is generated for the user.

In an implementation, the method further comprises detecting, by the detection unit 110, one of a mobility and an immobility of the user based on echo of the one or more ultrasonic waves, wherein the one of the mobility and the immobility is detected while converging the first non-audible frequency and the second non-audible frequency. Also, in an event the immobility of the user is detected, the method thereafter encompasses maintaining by the audio steering unit 112, an audio steering continuity at the close proximity to the spatial-location of the ears of the user based on the immobility of the user. More specifically, the method comprises detecting, by the detection unit 110, one of a match and a mismatch of echo of the one or more ultrasonic waves with one or more previously received echoes. In case of the successful match the immobility of the user is determined, otherwise the mobility of the user is determined. Therefore, the method then also encompasses detecting, by the detection unit 110, a change in the spatial-location of one or more of the ultrasonic signatures corresponding to the identified plurality of facial features based on the detection of the mismatch, e.g., detection of the mobility of the user. Also, based on the detection in the change in the spatial-location of one or more of the ultrasonic signatures corresponding to the identified plurality of facial features, the method further comprises detecting, by the detection unit 110, a new spatial-location of the ultrasonic signature corresponding to the identified plurality of facial features. Thereafter, the method also comprises detecting via the detection unit 110, a new spatial-location of ears of the user using the new spatial-location of the one or more of the ultrasonic signatures corresponding to the identified plurality of facial features. Additionally, the method encompasses detecting by the detection unit 110, a distance between a previous spatial-location of ears of the user and the new spatial-location of ears of the user to maintain an audio steering continuity at the close proximity to the new spatial-location of the ears of the user. Therefore, the sonic transmission to the new spatial-location of ears of the user is continued.

The method thereafter terminated at operation 816 after enabling the audio steering at the mobile device of the user.

The above flowchart illustrates an example method that may be implemented in accordance with the principles of the disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

### Example Use Cases:

Although the present disclosure illustrates a number of use cases, however a few are provided as below:

### Example Use Case 1-Co-Watching Experience

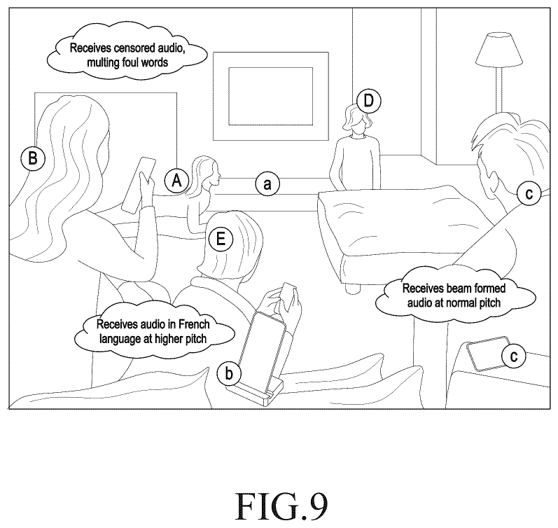

FIG. 9 is a diagram illustrating an example use case, according to various embodiments.

For example, FIG. 9 illustrates that multiple number of users are sitting in a room, few are watching TV and others are busy in their work. Also, based on the implementation of the features of the disclosure an audio provided by the TV is transmitted to users A, B and C through their personal devices (e.g., a, b and c respectively) without disturbing users D and E. Also, based on the implementation of the features of the disclosure, in the given use case for the user A objectionable audio content is censored based on user A's profile, for user B audio content is customized based on user B's preference (Like, user B may like hearing loud, and in French language) and for user C no customization is done. Also, the movement of users A, B and C is continuously tracked to provide continuous audio steering for the users A, B and C.

### Example Use Case 2-do not Disturb Others

In an event multiple people are present in a room and only one person say user 1 is watching TV. In the given event based on the implementation of the features of the disclosure, the TV is first connected to the personal device (say smartphone) of the user 1 with UWB connection and an audio is easily transmitted to the smartphone from the TV. The smartphone is configured to enable audio steering based on the implementation of the features of the disclosure and therefore can recognize and audio cast to user ears. The user 1 hence can freely watch TV and listen its audio without even disturbing others next to him.

### Example Use Case 3-Video Calling/Watching Experience in Public Places

Also, based on the implementation of the features of the disclosure a video calling/watching experience in public places can be provided without disturbing others as the disclosure enables a handheld device of a user to detect the user's ear location and audio is casted directly at the detected position. Furthermore, no extra hardware like earbuds/earphone are required and users can enjoy personal audio experience. The audio is transmitted to ears of the users by ultrasonic beamforming and the user voice is transmitted using already inbuilt microphone in device.

### Example Use Case 4-Multilingual Meeting Experience

Additionally, based on the implementation of the features of the disclosure, customization of the audio is also provided and therefore audio may be streamed to the handled devices of users in their preferred language, and casted directly at them without the need of external earbuds/earphones. This allows users to listen the audio clips in their preferred language, while also being attentive towards the presenter in a meeting.

Thus, the disclosure provides a novel solution of enabling audio steering at a mobile device of a user. The disclosure also provides a solution that is technically advanced over the currently known solutions as this brings a multi-user experience via enabling audio steering at a user device of multiple users. The disclosure is also technically advanced over the existing solutions as it eliminates the need of wired devices, in-ear wireless devices and/or audio steering speakers to direct an audio output around a particular user's ear. Also, the disclosure can direct sound only to a specific user (e.g., a registered user) in an event multiple users are present within a specific area range, and therefore provides an edge over the existing solutions. The disclosure is also technically advanced over the existing solutions as it provides seamless audio steering irrespective of the movement of the user. Moreover, the disclosure also delivers a customised audio to a particular user's ear(s) via audio steering and hence technically advanced over the currently known solutions. Additionally, the disclosure also provides a technical advantage over the currently known solutions of audio steering as a DIS of the disclosure is a two-dimensional signature (e.g., visual+ultrasonic) that improves precision in quick facial feature identification of a user.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for enabling audio steering, the method comprising:
generating one or more ultrasonic waves for use in registering a facial map of a user;
capturing one or more facial images of the user;
identifying a plurality of facial features of the user from the captured one or more facial images;
registering an ultrasonic signature for each of the identified plurality of facial features by registering echo of the one or more ultrasonic waves reflected from each of the identified plurality of facial features;
detecting a spatial location of two or more ultrasonic signatures associated with two or more facial features of the user within a specified vicinity of an electronic device of the user using one or more target ultrasonic waves;
detecting a spatial location of ears of the user using the detected spatial location of the two or more ultrasonic signatures associated with the two or more facial features of the user; and
converging a first non-audible frequency and a second non-audible frequency at a specified proximity to the spatial location of the ears of the user for producing an audible range of frequency for the user.

2. The method as claimed in claim 1, wherein converging the first non-audible frequency and the second non-audible frequency at the specified proximity to the spatial location of the ears of the user further comprises:
receiving audio data from one or more audio media devices,
processing the audio data to transform the audio data into a consumable form,
converting the processed audio data into the first non-audible frequency and the second non-audible frequency, and
directing the first non-audible frequency and the second non-audible frequency towards the specified proximity to the spatial location of the ears of the user to converge the first non-audible frequency and the second non-audible frequency at the specified proximity to the spatial location of the ears of the user.

3. The method as claimed in claim 2, wherein the audio data received from the one or more audio media devices is further processed to customize the audio data based on a preference of the user.

4. The method as claimed in claim 1, wherein the two or more ultrasonic signatures associated with the two or more facial features of the user are searched from a pre-stored set of ultrasonic signatures defined for the user.

5. The method as claimed in claim 4, wherein each ultrasonic signature from the pre-stored set of ultrasonic signatures is determined based on a mapping of a set of facial features of the user with a set of echoes of a set of ultrasonic waves reflected from the user.

6. The method as claimed in claim 1, the method further comprising detecting one of a mobility and an immobility of the user based on the echo of the one or more ultrasonic waves, wherein the one of the mobility and the immobility is detected while converging the first non-audible frequency and the second non-audible frequency.

7. The method as claimed in claim 5, the method further comprising maintaining an audio steering continuity at the specified proximity to the spatial location of the ears of the user based on the immobility of the user.

8. The method as claimed in claim 6, the method further comprising:
detecting one of a match and a mismatch of echo of the one or more ultrasonic waves with one or more previously received echoes,
detecting a change in the spatial location of one or more of the ultrasonic signatures corresponding to the identified plurality of facial features based on the detection of the mismatch,
detecting a new spatial location of the one or more of the ultrasonic signatures corresponding to the identified plurality of facial features based on the detection of the change in the spatial location of the one or more of the ultrasonic signatures corresponding to the identified plurality of facial features, and
detecting a new spatial location of the ears of the user using the new spatial location of the one or more of the ultrasonic signatures corresponding to the identified plurality of facial features.

9. The method as claimed in claim 5, the method further comprising detecting a distance between a previous spatial location of the ears of the user and the new spatial location of the ears of the user to maintain an audio steering continuity at the specified proximity to the new spatial location of the ears of the user.

10. The method as claimed in claim 1, wherein registering the ultrasonic signature for each of the identified plurality of facial features further comprises registering each of the identified plurality of facial features.

11. The method as claimed in claim 1, wherein the audio steering is enabled at the electronic device or any handheld device of the user.

12. The method as claimed in claim 1, wherein detecting the spatial location of the ears of the user further comprises using the detected spatial location of the two or more ultrasonic signatures to identify a relative location of the ears of the user, wherein the relative location of the ears of the user is identified to get exact coordinates of the ears with respect to the electronic device.

13. A system for enabling audio steering, the system comprising:
memory storing instructions; and
at least one processor,
wherein the instructions, when executed by the at least one processor individually or collectively, cause the system to:
generate, one or more ultrasonic waves for use in registering a facial map of a user;
capture, one or more facial images of the user;
identify, a plurality of facial features of the user from the captured one or more facial images;
register, an ultrasonic signature for each of the identified plurality of facial features at least by registering echo of the one or more ultrasonic waves reflected from each of the identified plurality of facial features;
detect a spatial location of two or more ultrasonic signatures associated with two or more facial features of the user within a specified vicinity of an electronic device of the user using one or more target ultrasonic waves;
detect a spatial location of ears of the user using the detected spatial location of the two or more ultrasonic signatures associated with the two or more facial features of the user; and
converge, a first non-audible frequency and second non-audible frequency at a specified proximity to the spatial location of the ears of the user for producing an audible range of frequency for the user.

14. The system as claimed in claim 13, wherein converging the first non-audible frequency and the second non-audible frequency at a specified proximity to the spatial location of the ears of the user, the instructions, when executed by the at least one processor individually or collectively, cause the system to:
receive audio data from one or more audio media devices;
process the audio data to transform the audio data into a consumable form;
convert the processed audio data into the first non-audible frequency and the second non-audible frequency; and
direct the first non-audible frequency and the second non-audible frequency towards the specified proximity to the spatial location of the ears of the user to converge the first non-audible frequency and the second non-audible frequency at the specified proximity to the spatial location of the ears of the user,
wherein the audio data received from the one or more audio media devices is further processed to customize the audio data based on a preference of the user.

15. The system as claimed in claim 13, wherein the two or more ultrasonic signatures associated with the two or more facial features of the user are searched from a pre-stored set of ultrasonic signatures defined for the user,
wherein each ultrasonic signature from the pre-stored set of ultrasonic signatures is determined based on a mapping of a set of facial features of the user with a set of echoes of a set of ultrasonic waves reflected from the user,
wherein the instructions, when executed by the at least one processor individually or collectively, cause the system to maintain an audio steering continuity at the specified proximity to the spatial location of the ears of the user based on the immobility of the user.

16. The system as claimed in claim 13, wherein the instructions, when executed by the at least one processor individually or collectively, cause the system to:
detecting one of a mobility and an immobility of the user based on echo of the one or more ultrasonic waves, wherein the one of the mobility and the immobility is detected while converging the first non-audible frequency and the second non-audible frequency;
detecting one of a match and a mismatch of echo of the one or more ultrasonic waves with one or more previously received echoes;
detecting a change in the spatial location of one or more of the ultrasonic signatures corresponding to the identified plurality of facial features based on the detection of the mismatch;
detecting a new spatial location of the one or more of the ultrasonic signatures corresponding to the identified plurality of facial features based on the detection of the change in the spatial location of the one or more of the ultrasonic signatures corresponding to the identified plurality of facial features; and
detecting a new spatial location of the ears of the user using the new spatial location of the one or more of the ultrasonic signatures corresponding to the identified plurality of facial features.

17. The system as claimed in claim 15, the method further comprising detecting a distance between a previous spatial location of the ears of the user and the new spatial location of the ears of the user to maintain an audio steering continuity at the specified proximity to the new spatial location of the ears of the user.

18. The system as claimed in claim 13, wherein registering the ultrasonic signature for each of the identified plurality of facial features further comprises registering each of the identified plurality of facial features,
wherein the audio steering is enabled at the electronic device or any handheld device of the user.

19. The system as claimed in claim 13, wherein detecting the spatial location of the ears of the user further comprises using the detected spatial location of the two or more ultrasonic signatures to identify a relative location of the ears of the user,
wherein the relative location of the ears of the user is identified to get exact coordinates of the ears with respect to the electronic device.

20. A non-transitory computer-readable storage medium storing one or more programs comprising instructions to, when executed by at least one processor of a system individually or collectively, cause the system to:
generate, one or more ultrasonic waves for use in registering a facial map of a user;
capture, one or more facial images of the user;
identify, a plurality of facial features of the user from the captured one or more facial images;
register, an ultrasonic signature for each of the identified plurality of facial features at least by registering echo of the one or more ultrasonic waves reflected from each of the identified plurality of facial features;
detect a spatial location of two or more ultrasonic signatures associated with two or more facial features of the user within a specified vicinity of an electronic device of the user using one or more target ultrasonic waves;
detect a spatial location of ears of the user using the detected spatial location of the two or more ultrasonic signatures associated with the two or more facial features of the user; and
converge, a first non-audible frequency and second non-audible frequency at a specified proximity to the spatial location of the ears of the user for producing an audible range of frequency for the user.
